(19) United States
(12) Patent Application Publication
(10) Pub. No.: US 2023/0063551 A1
(43) Pub. Date: Mar. 2, 2023

(54) Wireless Electric Hair Clipper with Integrated Camera

(71) Applicant: CUTCAM, INC., San Diego, CA (US)

(72) Inventors: Kevin Kohatsu YEE, Poway, CA (US); Derek Angelo SILVERIO, San Diego, CA (US)

(21) Appl. No.: 17/734,467

(22) Filed: May 2, 2022

Related U.S. Application Data
(60) Provisional application No. 63/237,530, filed on Aug. 27, 2021.

(51) Int. Cl. B26B 19/38; H04N 5/232; H04B 1/3827

(52) U.S. Cl. CPC B26B 19/3873; H04N 5/23206; H04B 1/3833

(57) ABSTRACT

A wireless electric hair clipper system used to trim hair is disclosed. The wireless electric hair clipper system allows for viewing an area of hair from front, lateral and back while cutting the hair. The system includes a handheld electric hair clipper with a foldable wireless video camera providing a standardized, optimal viewing angle and a display unit including a wireless video monitor. The display unit works in conjunction with a wireless video camera to provide a series of simultaneous images and live monitoring options of the area where hair is being cut.

### CROSS REFERENCE TO RELATED APPLICATIONS

This application claims the benefit of U.S. Provisional Patent Application Ser. No. 63/237,530, entitled, “Integrated, Foldable Wireless Camera Arm with Electronic Gyroscope leveling Assistance in Portable Electric Clipper” filed Aug. 27, 2021, which is incorporated herein by reference.

### BACKGROUND OF THE INVENTION

The present invention pertains to the art of personal grooming systems. More particularly, the invention pertains to a wireless electric hair clipper system used to trim hair. The system is configured to cut the hair of the user of the system, i.e., for do-it-yourself hair cutting. The system is also configured for use by barbers to cut the hair of a client.

Known existing clippers do not have the ability to clearly show the back and sides of one's own head during the self-haircut process. The self-haircut process is often done with the use of an electric hair clipper, a handheld mirror, and a wall-mounted mirror. The reflections of the mirrored surfaces allow the user to visualize and roughly approximate the position of the clippers in respect to their head. Regardless, positioning of the handheld mirror and visualizing the position of clippers in relation to the head is not easy and it is difficult to see the back of one's own head. Also, users have difficulty in understanding the position and orientation of the clippers in three-dimensional space. The result is often poor haircuts since the user may mistakenly cut in an undesired location due to the difficulty in seeing the hair being cut or the position of the hair clipper relative to the head.

There are no known developed systems, or methods that allow for a front and rear view of the head during the grooming process, provide a standardized view to all users of the system and allow for portability. Although clippers in a variety of styles and designs have been developed for self-hair cutting in the past, all of them have problems in practice. Thus, there remains a need for an improved hair cutting system, particularly a system which provides an improved view of the back of the head during the grooming process. There also exists a need for an apparatus that is relatively unobtrusive in a professional or private setting, easily adapted to a variety of settings and ready to use with minimal training

### SUMMARY OF THE INVENTION

Considering the disadvantages of the prior art described above, the following summary is provided to facilitate an understanding of some of the innovative features unique to the present invention and is not intended to be a full description. In accordance with one aspect, the present invention is directed to a personal grooming system which eliminates the use of front and back mirrors while cutting hair. In a preferred embodiment, there is provided a wireless hair clipper system with a handheld hair clipper and a display unit. The electric hair clipper system has an integrated, foldable wireless video camera that wirelessly transmits live feed video stream to a video monitor of a smart device.

The handheld electric hair clipper includes a housing having a mounting portion with a retaining assembly. The clipper also includes a motor driving a set of blades for cutting hair. A switch is provided to turn the motor on and preferably controls the motor's speed. A camera is mounted on an arm operatively connected to the mounting portion and configured to take images of the blades cutting hair during operation. The arm is configured to be moved between a stowed position recessed in the housing and a deployed position spaced from the housing. When the arm is in the deployed position, the camera is automatically aimed at the hair at a proper predetermined angle and is placed at an ideal viewing distance from the hair. The arm is held securely at the proper predetermined angle during grooming by the retaining assembly. Furthermore, the foldable, integrated camera architecture provides portability, ease of storage and standardized viewing angle to allow easier following of step-by-step guided tutorials while using the system. A wireless transceiver is operatively connected to the camera and configured to wirelessly transmit the images of the user's head and of the blade cutting hair. A battery is operatively connected to provide power to the motor, the transceiver, and the camera. A processor is configured to track information regarding the blade, the motor, the battery, and the camera. A switch, mounted on the housing, is configured to automatically turn on the camera when the arm is moved from the stowed position to the deployed position.

The display unit includes a main housing with a display and a transceiver operatively connected to the display. Preferably, the display unit is a cellular telephone, smart phone or tablet and retains the familiarity of the handheld mirror. The transceiver is arranged to receive images and information regarding the blade, the motor, the battery, and the camera from the wireless transceiver of the clipper. The display is configured to present the images in a clear manner. The wireless transceiver of the clipper and the transceiver of the display are configured to employ one or more of Bluetooth, Bluetooth Low Energy, and Wi-Fi communication to transfer information therebetween. A switch is configured to automatically connect the wireless transceiver and the transceiver when the arm is moved from the stowed position to the deployed position. The display unit is configured to display the information regarding the blade and display a graphic image of designated cut lanes overlaying an image of the hair to aid in the haircutting process.

Also, the clipper can optionally employ a vibration motor configured to provide haptic feedback alerting when the blades stray too far from the designated cut lanes. The haptic feedback includes a pulse distinguishable from clipper motor vibration. The cell phone includes a memory configured to store a record of a client's haircut history. The history preferably includes at least one of the following: an amount of time the haircut lasted, the number and type of guards used and in what order, before and after images of the haircut, the time the haircut occurred, and notes about the haircut.

The handheld electric hair clipper preferably includes one or more optional features, such as a flashlight mounted on the housing. An electronic gyroscopic module is preferably mounded in the housing and configured to allow the user to visualize an orientation and level of the electric hair clipper in three-dimensional space on the display unit while cutting their own hair. The clipper may also have a blending device, mounted on the housing, in the form of a lever or dial which adjusts the length of hair being cut. Preferably a physical button located towards the front of the clipper is programmed to enlarge or shrink the image displayed on the cellphone or start recording the images from the camera.

The system also optionally includes guards and may employ magnets for securing a select guard onto the clipper. Each guard preferably has a plastic body and an RFID tag molded into the plastic body. The cell phone is configured to recognize which guard is being used based on the RFID tag. The cell phone provides instructions in a video lesson that is synchronized with the recognized guard.

In use, the clipper will transmit images of the blades cutting hair in a stream of video data which is received by the cell phone and presented on the display. When the built-in rechargeable battery of the wireless video monitor is properly and adequately charged, the built-in rechargeable battery of the wireless video camera is properly and adequately charged, and the frequencies of the transceivers are compatibly tuned, the handheld wireless video monitor assembly will operate without external power requirements or connections and produce high quality images and video monitoring. While cutting the hair, additional information regarding the battery and the blades is also displayed. The camera is turned on by moving the arm from a stowed position in the housing to a deployed position spaced from the housing. Information regarding the blades, including a graphic image of designated cut lanes overlaying an image of the hair, is displayed and an alert is provided when the blades stray too far from the designated cut lanes. The display unit has dedicated application software configured to determine the cut lanes based on received video data from the clipper and to alert the user via one or more of audio, visual, and haptic notifications when the user moves out of the cut lanes.

Preferably the system includes electronic gyroscopic assistance which helps the user better understand the position of the clipper in 3D space. Also, a “universal” viewing angle ensures that, when the user views tutorial videos on how to use the device, the viewing angle is the same as in the tutorial videos.

The preferred embodiments provide several advantages and eliminates the need to use a front and/or back mirror during a haircut. The system provides a standardized view of all angles of the head during the self-grooming process and allows for viewing the front and the back of the head, while being relatively unobtrusive in a professional or private setting and can be easily adapted to a variety of settings or locations. The system is easy to use, can be employed with minimal training and is relatively unobtrusive in use.

Additional objects, features and advantages of the present invention will become more readily apparent from the following detailed description of a preferred embodiment when taken in conjunction with the drawings wherein like reference numerals refer to corresponding parts in the several views.

### BRIEF DESCRIPTION OF THE DRAWINGS

FIG. 1 shows a perspective top side view of a handheld electric clipper with a camera arm in closed state in accordance with a preferred embodiment of the invention.

FIG. 2 shows a perspective top side view of the handheld electric clipper of FIG. 1 with the camera arm in the open state.

FIG. 3 shows a perspective top front view of the handheld electric clipper of FIG. 1 with a camera arm in the open state with the camera visible.

FIG. 4 shows a schematic view of components of the handheld electric clipper of FIG. 1.

FIG. 5 shows a front view of a display unit in accordance with a preferred embodiment of the invention.

### DETAILED DESCRIPTION OF THE INVENTION

Detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting but merely as a representative basis for teaching one skilled in the art to variously employ the present invention.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe a relationship between one element or feature and one or more other elements or features as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited in order or otherwise by these terms, unless the context indicates otherwise. These terms may be used to distinguish one feature/element from another feature/element. Thus, a first feature/element discussed below could be termed a second feature/element and, similarly, a second feature/element discussed below could be termed a first feature/element without departing from the teachings of the present invention.

Throughout this specification and the claims which follow, unless the context requires otherwise, the word “comprise”, and variations such as “comprises” and “comprising”, means various components can be co jointly employed in the methods and articles (e.g., apparatuses including device and methods). For example, the term “comprising” will be understood to imply the inclusion of any stated elements or steps but not the exclusion of any other elements or steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. Any numerical values given herein should also be understood to include about or approximately that value, unless the context indicates otherwise. Any numerical range recited herein is intended to include all sub-ranges subsumed therein.

The following detailed description should be read with reference to the drawings in which similar elements in different drawings are numbered the same. The detailed description and the drawings, which are not necessarily to scale, depict illustrative embodiments and are not intended to limit the scope of the disclosure. Instead, the illustrative embodiments depicted are intended only as exemplary. Selected features of any illustrative embodiment may be incorporated into another embodiment unless clearly stated to the contrary. While the disclosure is amenable to various modifications and alternative forms, specifics thereof have been shown by way of example in the drawings and will be described in detail. It should be understood, however, that the intention is not to limit aspects of the disclosure to the illustrative embodiments described. On the contrary, the intention is to cover all modifications, equivalents and alternatives falling within the spirit and scope of the disclosure.

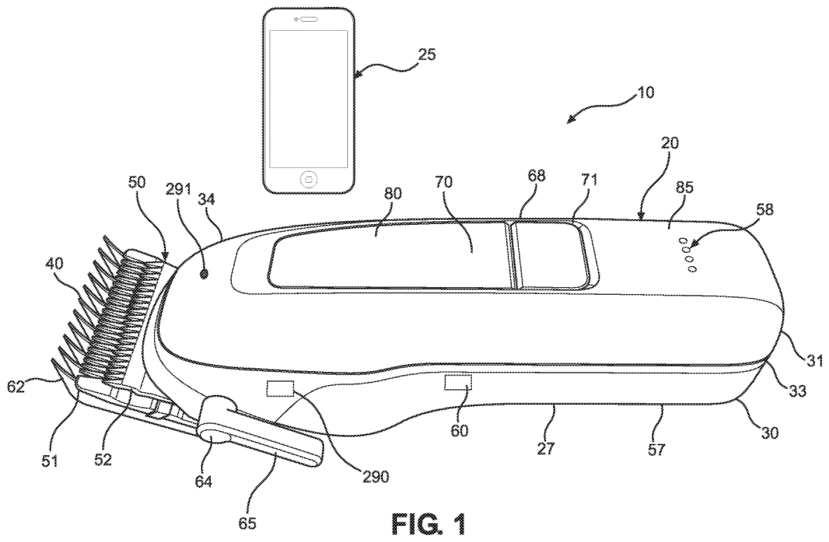

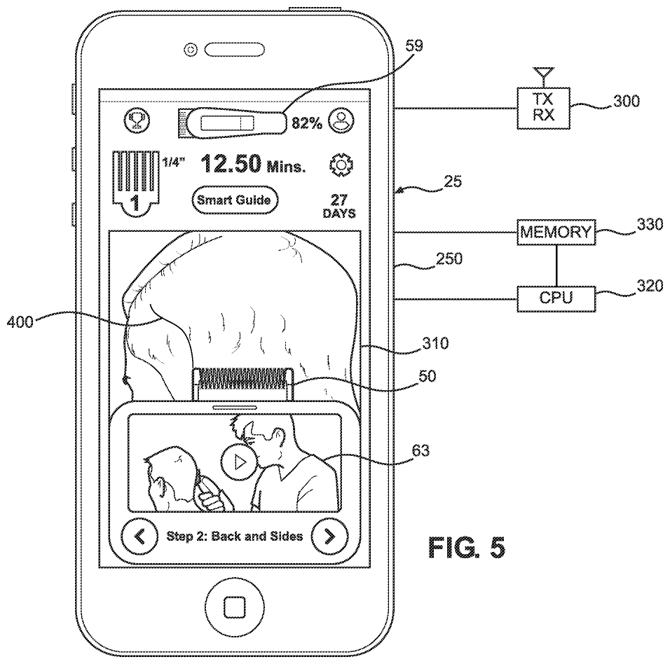

A wireless electric hair clipper system 10 is shown throughout the several views of the drawings. System 10 includes both a handheld electric hair clipper 20, best seen in FIGS. 1-4, and a corresponding display unit 25 best seen in FIGS. 1 and 5. Handheld electric clipper 20 and display unit 25 work together to allow a user to view a given hair style from multiple angles, without the requirement of the user twisting or moving their neck and body while cutting hair.

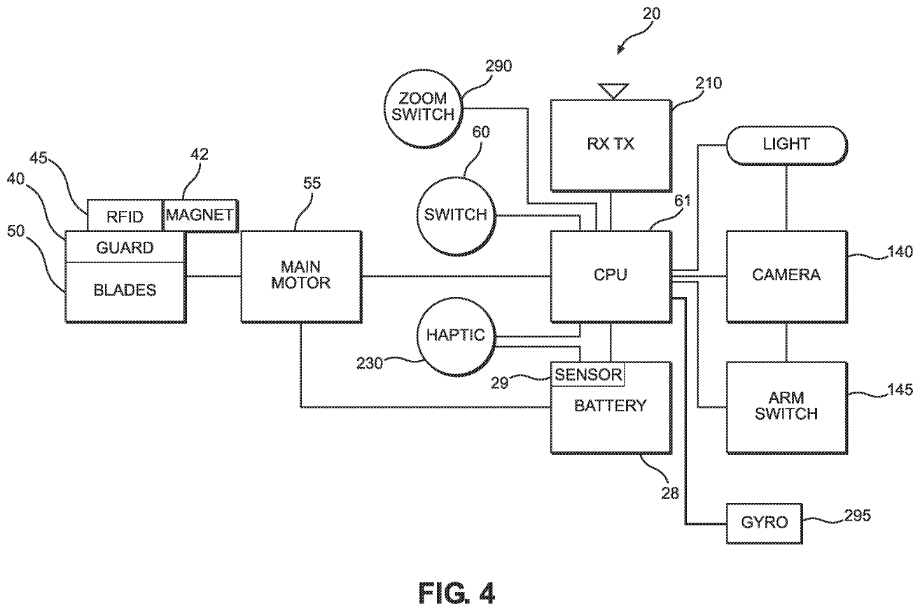

Handheld electric clipper 20 has a housing 27 shaped and sized to be held in one hand of the user. Handheld electrical clipper 20 is shown as a cordless type which is powered by a self-contained rechargeable battery 28 (FIG. 4). However, it is to be understood that the embodiments are not limited to clippers of this type. Housing 27 is preferably formed with a base portion 30 and a lid portion 31 which meet along a line 33. Base portion 30 and lid portion 31 are fastened together, preferably by fasteners, not separately shown. Housing 27 is preferably made of plastic to provide a rigid structure that holds the various components of clipper 20. Any suitably material may be employed, such as molded nylon for example.

As shown in FIGS. 1 and 4, housing 26 has a front end 34 supporting a guard 40. Preferably multiple, differently sized guards 40 are provided, with each guard 40 including one or more magnets 42 (FIG. 4) to secure the selected guard 40 to clipper 20. The magnets 42 allow for the guards 40 to be easily exchanged. As shown in FIG. 4, an RFID tag 45 is also preferably provided on each guard 40 so that the various guards are easy to identify. Blades 50 include a stationary comb blade 51 which is fixedly mounted at front end 34 of housing 27, and a cooperating movable blade or shear 52 mounted next to stationary comb blade 51. In a manner known in the art, moveable shear 52 will move in a reciprocating manner with respect to stationary comb blade 51 when clipper 20 is in operation. Movable shear 52 is mounted in housing 27 so as to be pressed against stationary comb blade 51 with an appropriate pressure to properly cut hair. The blades are sharp and preferably made of steel, although other materials could be employed. Preferably, both blades 51, 52 are removable for sharpening.

A motor 55 is in housing 27 as best represented in FIG. 4. Motor 55 is located in front 34 of housing 27 near blades 50 and is securely mounted to housing 27. Motor 55 is preferably a rotary electric motor and arranged to provide power to movable shear 52 to oscillate. The details of motor 55 and the motor's connection to movable shear 52 are conventional and more details are found in U.S. Pat. No. 3,589,007, incorporated herein by reference.

Referring particularly to FIGS. 1 and/or 4, motor 55 receives power from a self-contained rechargeable battery 28 which is located at a rear end 57 of housing 27. Battery 28 is contained within housing 27. Battery 28 is a conventional rechargeable battery that may be charged with a charger (not shown). Preferably clipper 20 can be connected to an external power source (also not shown) to recharge battery 28. Alternatively, battery 28 can be replaced with a fresh battery, as needed. Battery 28 is provided with a sensor 29 to determine a level of charge in battery 28. Sensor 29 may be connected to a light 58 mounted on housing 27 with light 58 being configured to display the level of charge. Preferably, light 58 on housing 28 is replaced with a signal 59 on display unit 25 which displays the level of charge.

Hair clipper 20 is preferably charged overnight or may be placed in the charger whenever clipper 20 is not being used. The power provided to motor 55 is controlled by a user operated switch 60. Switch 60 may simply regulate the amount of electricity to flow to motor 55 or completely prevent the electricity from reaching motor 55. Alternatively, switch 60 may be arranged to send a signal to a central processing unit 61 that will control the motor's functions. Having switch 60 provide for a variable speed is desirable since certain cutting operations are best accomplished at different speeds. For example, rough cutting is best done at high speeds while fine cutting is best accomplished at lower speeds.

Guard 40 is located adjacent blades 51, 52. Guard 40 is provided with protrusions or teeth 62 that space blades 51, 52 from hair 26 of the user. Guards 40 thereby set the length of hair 59 being cut. Guard 40 also protects the subject's skin from being cut. In order to adjust the distance between set of blades 51, 52 and hair 26, a set of guards 40 are used that each individually mechanically couple to hair clipper 20. Each guard 40 is designed to position a set of blades 51, 52 a fixed specific distance from hair 26. The set of fixed-distance guards 40 includes guards with a range of fixed distances, which provide for a range of haircut lengths. Barber/hair stylist 63 chooses the fixed-distance guard 40 that corresponds to the length of hair desired, and mechanically switches one guard 40 for another when it is necessary to adjust the cut length. Because it is necessary to mechanically remove one fixed-distance guard 40 and put another one in place on clipper 20 each time it is desired to adjust the cut length, the barber/hair stylist 63 is continually removing one guard and replacing it with another.

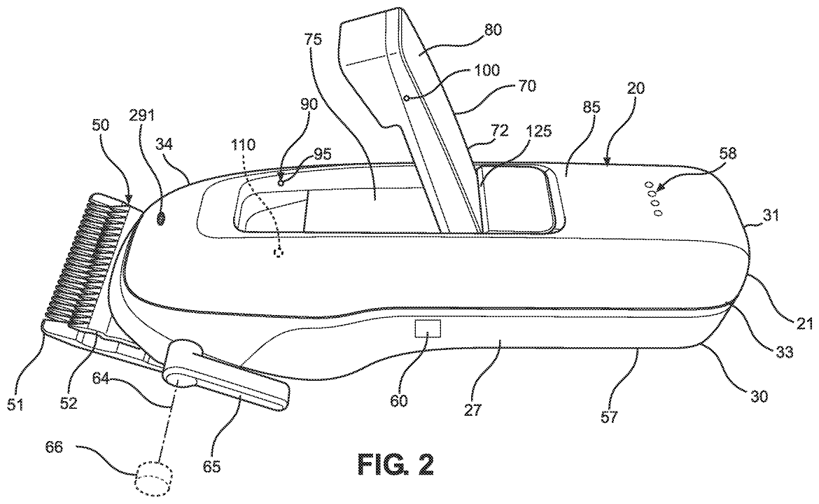

A length adjustment device 64 is mounted in housing 26 and is provided to adjust a relative positioning between blades 51 and 52. Length adjustment device 64 can take the form of a lever 65 as shown in Figure. Lever 65 may be raised toward front end 34 to provide a close cut or may be pulled back to reposition blades 51, 52 relative to one another to provide a longer cut. The length of the cut hair may be continuously adjusted during cutting to easily change the closeness of a cut between guide comb lengths. Length adjustment device 61 may be used to provide for length blending and fading of hair 26 during cutting. In order to more easily hold clipper 20, taper lever 65 can be replaced with a dial 66, as illustrated in phantom in FIG. 2, or the smallest form factor as possible so as to be easier for users to “choke” up on the hair clipper 20 with a grip closer to front end 32 so the user's thumb does not interfere/collide with lever 65 when cutting during self-operation. This is not an issue when operating on another person, only when used to cut one's own hair in many hand gripping positions.

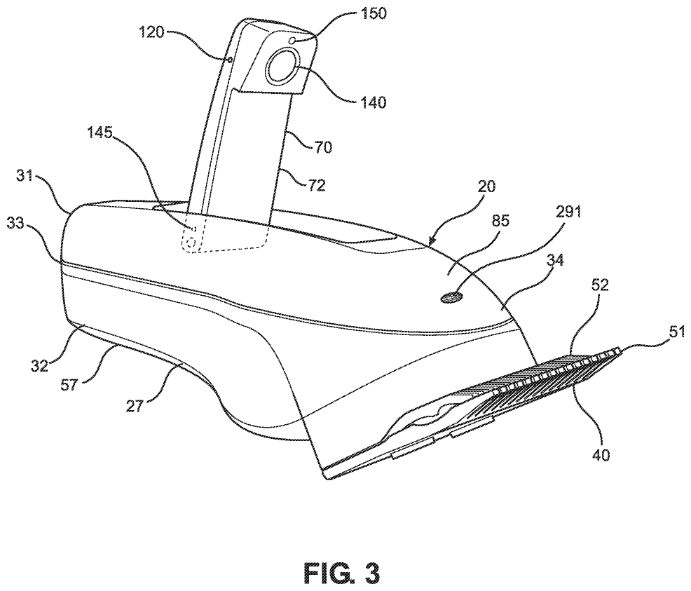

In a middle portion 68 of housing 27 there is a camera arm 70. Arm 70 pivots from a stowed position 71, shown in FIG. 1, to a deployed position 72, shown in FIGS. 2 and 3. A cavity 75 is formed in housing 26 with a shape that complements arm 70 so that when arm 70 is in stowed position 71 an upper surface 80 of arm 70 is substantially flush with an outer surface 85 of the housing 26. A seen in FIGS. 2 and 3, arm 70 is provided with a retaining assembly 90. Housing 27 includes a retaining assembly generally shown at 90 which is provided to secure arm 70 in stowed position 71 and secured arm 70 in deployed position 72. Retaining assembly 90 preferably includes a detent mechanism 95 on one side of arm 70 that retains arm 70 in stowed position 71. In a similar manner, a protrusion 100 located on the other side of arm 70 engages a recess 110 located in housing 26. When arm 70 is pushed to stowed position 71, protrusion 100 will snap into recess 110 thus holding arm 70 securely in place. Retaining assembly 90 biases arm 70 toward deployed position 72 with a spring (not shown), with the degree of pivoting being limited as arm 70 hits a stop surface 125 traversing recess 110. With this arrangement, arm 70 is automatically positioned and retained in deployed position 72 as the spring forces arm 70 against stop surface 125 and prevented from returning to stowed position 71 until the force of the spring is overcome.

Turning to FIG. 3, front end 34 of clipper 20 is shown. In this orientation, a camera 140 can be seen. A switch 145 is provided on arm 70 so that, when camera arm 70 pivots to deployed position 72, switch 145 senses the position of arm 70 and sends a signal to automatically turn on camera 140. As noted above retaining assembly 90 holds arm 70 in deployed position 72. Retaining assembly 90 thereby holds camera 140 at a predetermined viewing angle and distance relative to the hair being cut.

Camera arm 70 has a light 150 located thereon which is preferably a steady colored LED light. When illuminated, light 150 indicates that camera 140 is in streaming mode and is actively transferring data to display unit 25. This advantageously notifies people that camera 140 is on to address any privacy concerns. Light 150 faces front end 34 of clipper and 20 can be seen by people being recorded by camera 140.

FIG. 4 shows a schematic of the various components of clipper 20, preferably all located within housing 27. Some of the components are the same as shown in FIGS. 1-3 and some are additional. A central processing unit 61 is provided to control the various functions of clipper 20. Central processing unit 61 is connected to a transceiver 210, a switch 60, a haptic motor 230, main motor 55, battery 28 and a sensor 29. Transceiver 210 is preferably a Wi-Fi transceiver, but any wireless transceiver may be used. Transceiver 210 transmits information back and forth between clipper 20 and display unit 25. Haptic motor 230 provides feedback to barber 63. A button 290 is mounted on housing 27 and, when pressed, will case display unit 25 to enlarge the image in display 310 (FIG. 5). An electronic gyroscopic module 295 is also provided and configured to allow a user to visualize an orientation and level of the handheld electric hair clipper 20 in three-dimensional space on display unit 25 while cutting hair. Electronic gyroscopic module 295 preferably includes an accelerometer and is configured to record the motion of clipper 20 during use.

FIG. 5 shows display unit 25, which is illustrated as a cell phone 250, having a transceiver 300 that cooperates with transceiver 210. Display unit 25 is also provided with a display 310, a processor or central processing unit 320 and memory 330 for running various applications and performing other functions of cell phone 250. Memory 330 includes two different types of memory, namely, volatile memory and non-volatile memory. The volatile memory is computer memory that requires power to maintain the stored information, such as random access memory (RANI). The non-volatile memory can retain stored information even when the wireless communication device is not powered up. Some illustrative examples of non-volatile memory include flash memory, ROM memory, and hard drive memory.

Hair clipper 20 can be used in several modes. In a first mode, hair clipper 20 may be used in a conventional manner. In this mode a first person, such as barber 63, cuts a second person's hair 26. Battery 28 of clipper 20 is first charged. Once battery 28 is charged, clipper 20 is ready for use. Arm 70 is placed in stowed configuration 71 and power switch 60 is depressed. Switch 60 sends a signal to central processing unit 200 which in turn sends a signal to allow battery 28 to send power to main motor 55. Main motor 55 is preferably a rotary style direct current motor, but other types of motors may be used. Main motor 55 drives blades 51, 52 so that movable shear 52 oscillates from side to side and cooperates with stationary comb blade 51 to cut hair 26. Blades 51, 52 are spaced from a person's skin so that a certain length of hair 26 is cut. Blades 51, 52 are spaced by guard 40. Guard 40 is preferably formed of plastic and is a certain length so that a certain length of hair is cut. Different sizes of guards may be employed. One guard may provide for cutting hair short, while another may be employed for cutting hair at a longer length. A fine adjustment of the length of hair cut is provided by blending lever 65 which moves blade 52 relative to guard 40. Clipper 20 is then placed against the skin and moved to cut hair 26.

In a second mode of operation, a user can employ system 10 to cut their own hair without the utilization of a wall-mounted mirror during the hair grooming process. Arm 70 is released to deployed position 72 whereat arm 70 will automatically stop at a predetermined angle due to the biasing of the spring and the engagement with stop surface 125. Through arm switch 145, camera 140 will turn on automatically and begin to record images. Preferably, movement of arm 70 will also trigger the central processing unit 200 to wirelessly connect clipper 20 with display unit 25 by sending a signal with transceiver 210. Various communication protocols, such as Bluetooth, Bluetooth Low Energy, CDMA, WCDMA, GSM, UNITS, or other wireless communication system such as wireless local area network (WLAN), Wi-Fi or WiMAX or WIFI Direct, may be employed. Preferably clipper 20 and display unit 25 communicate using the Wi-Fi protocol. When built-in rechargeable battery 260 of display unit 25 is properly and adequately charged, and built-in rechargeable battery 28 of clipper 20 is properly and adequately charged, electric hair clipper 20, camera 140 and display unit 25 can operate without external power requirements or connections and provide the user a viewing angle of any position on their head during the hair self-grooming process.

Several variations of clipper system 10 are contemplated. For example, display unit 25, when in the form of cell phone 250, will provide video tutorials and guidance even, if desired, while hair 26 is being cut. Also, haptic feedback in the form of haptic motor 230 is used in conjunction with audible and visual notifications from cell phone 250 to help aid in the self-hair cutting process. The feedback is preferably used to alert users 63 when they stray too far from the designated “boundaries” or “cut lanes” as seen by an overlayed graphic interface 400 on the smartphone image of the user's head/hair in real-time. This vibration alert has a different pulse or “signature” so that it is distinguishable from the clipper motor vibration.

Button 290 located towards front end 34 of clipper 20 has various uses. A flashlight 291, which is preferably a bright LED light may also be added to front end 34 so that clipper 20 may be used in low light situations. Button 290 is a programmable button allowing for pre-set actions to be conveyed from clipper 20 to cell phone 250. This type of configuration allows the user to focus only on the hand holding clipper 20, rather than attempting to perform operations with both hands. Button 290 preferably has a hotkey type of functionality, programmable beforehand. The user could utilize cell phone 250 to set button 290 to perform any one of several desired operations. For example, button 290 instructs camera 140 to zoom in or zoom out for a corresponding change of view on cell phone display, facilitating fine tuning/accuracy of the cutting of certain areas like carving lines and cleaning the neck and ears. Button 290 also causes cell phone 250 to start capturing video through its own camera or recording display 310 to save the video being live streamed from camera 140. This feature could be particularly useful for professional barbers wishing to capture their work for social media. Currently, in order to do this, barbers must hold a cell phone with their other hand and record their artwork, limiting their manual dexterity, or have another person present to take video. This interrupts the flow of a haircut and creates extra work. The function also provides the ability to capture dual-angle footage of a haircut, both from the smartphone angle and the clipper angle.

Cell phone 250, in combination with gyroscopic module 295, is preferably used to capture natively information about the haircutting process. Once the information about the haircut is recorded in memory 330, the information can be shared or used in training new barbers, new skills, or even “monitoring” the work of their apprentices/employees/stylists/etc. to ensure optimal and consistent results. For example, gyroscopic module 295 is configured to measure the position and motion of clipper 20 during use. The barbering/haircut process requires a series of fine motor movements which constitute specialized motions. One such motion is referred to as the “scoop”, which is a specialized motion for cutting hair wherein clipper 20 is moved in a curved path. When a master barber uses clipper 20, ideal specialized motions are recorded as control data by gyroscopic module 295 and stored in cell phone 250. The control data are then incorporated into tutorials, which are loaded onto cell phone 250 and ,more specifically, into memory 330. When a user or trainee barber is performing a haircut that requires specialized motions, system 10 will compare the movement of clipper 20, when used by the user, with the control data regarding the ideal specialized motion of clipper 20, when used by the master barber. The tutorials will then provide feedback to the user to correct how the user moves clipper 20 during such motions thus providing feedback showing how an actual motion of hair clipper 20 differs from an ideal motion of hair clipper 20. Eventually the user will be able to synchronize the motion of clipper 20 with the ideal specialized motion, such as the “scoop,” employed by the master barber. Preferably, there is a mode wherein a user replicates the desired motions without actually cutting hair. Such a mode will avoid someone risking getting a bad haircut while the user is still learning. Gyroscope module 295 also provides information about the position and the orientation of clipper 20 in space. For example, it is useful to know if clipper blade is 52 oriented straight so that hair 26 is being cut evenly. There is a ‘visualization’ of clipper 20 in display 310, that functions like a bubble level.

Also, once the haircut is finished camera 140 will be used by barber 63 or the self-haircut enthusiast to view the back of their head when finished to see the results with better clarity/confidence. Currently, the client (in a barbershop setting) is presented with a small handheld mirror and must angle it in relation to the larger wall mirror to see behind their own head. Using clipper system 10, barber 60 can hold hair clipper 20 and pan across the client's head while still seated in a chair and the client can view the image via display 310 that is used primarily for this final review. This invites an additional level of scrutiny/ownership that will be up to barber 63.

Additional advantages are present when the haircuts are recorded in the smart phone. For example, the ability for barber 63 to keep a living record of the client's haircut history in a more robust and seamless way with data that has never been able to be captured with just a scheduling app. The information recorded preferably includes the amount of time the haircut lasted, which guards where used, images of the hair before and after a haircut, when the haircut occurred and various professional notes that help the barber understand client's needs, such as hair cut lengths and styles, along with conversation topics. In a similar manner, a client can maintain their own haircut records.

Guard 40 is preferably provided with some indicator that is sensed by clipper 20, such as RFID tag 45 molded into guard body 40. Clipper 20 would then determine what size of guard is being employed during the haircut. This determination allows cell phone 250 to recognize which guard 40 is being used and therefore cell phone 250 can be used in following instructions provided in a video tutorial or lesson for a specified haircut. Therefore, when the on-screen tutorial notification calls for a guard change, barber 63, electric hair clipper 20 and cell phone 250 will all be synchronized. The tutorials are also produced based on the predetermined viewing angle and distance of camera 140 set by retaining assembly 90. As such, the view seen in the tutorial matches the view taken by camera 140.

While preferred embodiments have been shown and described, many variations are possible. With time, additional features may be employed. The shape or configuration of the platform or the interior configuration may be changed to suit the system or equipment with which it is used. The invention as described provides a reasonably priced assembly, having high reliability factors, and small in weight and size, which makes it portable and easy to travel with or stow in most bathroom drawers and travel bags. The cutting assembly is of durable configuration made of high-quality material. The inner parts of the assembly can sustain the high working temperature and repeated usage.

Based on the above, it should be clear this invention establishes a wireless electric hair clipper system and method which allows for viewing an area of hair from front, lateral and back while cutting the hair. The system includes a handheld electric hair clipper with a foldable wireless video camera providing a standardized, optimal viewing angle and a display unit including a wireless video monitor, such as a smart phone. The display unit works in conjunction with the wireless video camera to provide a series of simultaneous images and live monitoring options of the area where hair is being cut, with the overall arrangement retaining the familiarity of using an electric hair clipper, mirror, and handheld mirror. Although described with reference to preferred embodiments of the invention, it should be readily understood that various changes and/or modifications can be made to the invention without departing from the spirit thereof. In general, the invention is only intended to be limited by the scope of the following claims.

1. A wireless electric hair clipper system comprising:
a handheld electric hair clipper including:
a housing having a retaining assembly,
a blade for cutting hair,
a motor for driving the blade,
a camera mounted on an arm operatively connected to the housing and configured to take images of the blade while cutting hair during, wherein the arm is configured to be moved between a stowed position in the housing and a deployed position spaced from the housing, wherein the camera is held, by the retaining assembly, at a predetermined viewing angle and distance relative to the hair being cut,
a wireless transceiver operatively connected to the camera and configured to wirelessly transmit the images of the blade while cutting hair,
a battery mounted in the housing and operatively connected to provide power to the motor, the wireless transceiver, and the camera, and
a processor configured to track information regarding at least one of the blade, the motor, the battery and the camera; and
a display unit including:
a main housing,
a display located in the main housing, and
a transceiver operatively connected to the display and configured to receive the images and the information regarding at least one of the blade, the motor, the battery and the camera from the wireless transceiver, wherein the display is configured to present the images.

2. The wireless electric hair clipper system according to claim 1, further comprising a switch, mounted on the housing, configured to automatically turn on the camera when the arm is moved from the stowed position to the deployed position.

3. The wireless electric hair clipper system according to claim 2, wherein the wireless transceiver and the transceiver are configured to employ a Wi-Fi protocol and the switch is configured to pair the wireless transceiver and the transceiver when the arm is moved from the stowed position to the deployed position.

4. The wireless electric hair clipper system according to claim 1, further comprising a light on the arm and near the camera, the light being configured to turn on when the camera is on.

5. The wireless electric hair clipper system according to claim 1, further comprising an electronic gyroscopic module having an accelerometer for measuring motion of the clipper, said module configured to allow a user to visualize an orientation and level of the handheld electric hair clipper in three-dimensional space on the display unit.

6. The wireless electric hair clipper system according to claim 1, further comprising a blending device, mounted on the housing, including a dial.

7. The wireless electric hair clipper system according to claim 6, wherein the display unit is a cell phone and a flashlight is mounted on the housing of the handheld electric hair clipper.

8. The wireless electric hair clipper system according to claim 1, wherein the display unit is configured to display the information regarding the blade including a graphic image of designated cut lanes overlaying an image of the hair based on the predetermined viewing angle and distance.

9. The wireless electric hair clipper system according to claim 8, wherein the housing further comprises a vibration motor configured to provide haptic feedback alerting when the blade strays from the designated cut lanes, the haptic feedback including a pulse distinguishable from clipper motor vibration.

10. The wireless electric hair clipper system according to claim 1, wherein the handheld electric hair clipper further comprises a button located towards a front of the handheld electric hair clipper that programmed to enlarge or shrink an image displayed on the display unit or start recording the images from the camera.

11. The wireless electric hair clipper system according to claim 1, wherein the display unit includes a memory configured to store a record of a client's haircut history including at least one of: an amount of time a haircut lasted, a number and type of guards used and in what order, before and after images of the haircut, the time the haircut occurred, and notes about the haircut.

12. The wireless electric hair clipper system according to claim 7, further comprising a guard which includes magnets for securing the guard onto the handheld electric hair clipper, wherein each guard has a plastic body and an RFID tag molded into the plastic body, wherein the display unit is configured to recognize which guard is being used based on the RFID tag.

13. The wireless electric hair clipper system according to claim 12, wherein the display unit provides instructions in a video lesson that is synchronized with the guard and with the predetermined viewing angle and distance.

14. A handheld electric hair clipper including:
a housing having a retaining assembly,
a blade for cutting hair,
a motor for driving the blade,
a camera mounted on an arm operatively connected to the retaining assembly and configured to take images of the blade while cutting hair during, wherein the arm is configured to be moved between a stowed position in the housing and a deployed position spaced from the housing, wherein the camera is held, by the retaining assembly, at a predetermined viewing angle and distance relative to the hair being cut,
a wireless transceiver operatively connected to the camera and configured to wirelessly transmit the images of the blade and hair,
a battery, mounted in the housing and operatively connected to provide power to the motor, the wireless transceiver, and the camera, and
a processor configured to track information regarding at least one of the blade, the motor, the battery and the camera.

15. The handheld electric hair clipper according to claim 14, further comprising a switch, mounted on the housing, configured to turn on the camera when the arm is moved from the stowed position to the deployed position.

16. The handheld electric hair clipper according to claim 14, further comprising a light on the arm and near the camera, the light being configured to turn on when the camera is on, another light mounted near the blades for illuminating the hair, and a blending device including a dial.

17. A method of cutting hair with a wireless electric hair clipper system having a handheld electric hair clipper including a housing having retaining assembly, a blade, a motor, a camera mounted on an arm, a wireless transceiver, a battery mounted in the housing, and a processor configured to track information regarding the blade, the motor, the battery and the camera;
and a display unit including a main housing having a display and a transceiver, said method comprising:
holding the camera, with a retaining assembly, at a predetermined viewing angle and distance relative to hair being cut;
driving the blade with the motor to cut the hair;
transmitting images of the blade while cutting the hair;
receiving the images with the display unit;
presenting the images on the display while cutting the hair; and
displaying information regarding the battery and the blade.

18. The method according to claim 17, further comprising:
turning on the camera by moving the arm from a stowed position in the housing to a deployed position spaced from the housing;
providing instructions in a video lesson that is synchronized with the predetermined viewing angle and distance, and providing feedback showing how an actual motion of the hair clipper differs from an ideal motion of the hair clipper.

19. The method according to claim 17, further comprising:
displaying information regarding the blade including a graphic image of designated cut lanes overlaying an image of the hair; and
providing an alert when the blade strays from the designated cut lanes.

20. The method according to claim 17, further comprising:
storing a record of a client's haircut history including recording an amount of time a haircut lasted, a number and type of guards used and in what order, at least before and after images of the haircut, the date and/or time the haircut occurred, and notes about the haircut.
